(19) United States
(12) Patent Application Publication
(10) Pub. No.: US 2026/0037414 A1
(43) Pub. Date: Feb. 5, 2026

(54) MACHINE LEARNING BASED SOFTWARE TESTING

(71) Applicant: CODIUM LTD., Ramat-Gan (IL)

(72) Inventors: Gadi ZIMERMAN, Hod-Hasharon (IL); Itamar FRIEDMAN, Ramat Gan (IL)

(21) Appl. No.: 19/473,664

(22) PCT Filed: Apr. 3, 2024
(86) PCT No.: PCT/IL2024/050341

§ 371 Date: Oct. 8, 2025

Related U.S. Application Data
(60) Provisional application No. 63/457,094, filed on Apr. 4, 2023.

(51) Int. Cl. G06F 11/3668

(52) U.S. Cl. CPC G06F 11/3684; G06F 11/3676

(57) ABSTRACT

There is provided a system and method of automatic software testing. The method includes obtaining an input including software code of a software program and metadata, and feeding the input to a machine learning model to generate a test suite usable for testing the program. The test suite comprises a set of tests meeting a predefined condition. The test suite is generated by generating at least one question related to at least one of: expected intents of one or more sections of the software code, or tests for testing the sections, and presenting the at least one question to a user; upon receiving feedback from the user, analyzing the feedback with respect to the predefined condition, and determining whether to generate at least one new question; and, in response to an affirmative determination, repeating the above process with respect to the new question, until the predefined condition is met.

### TECHNICAL FIELD

The presently disclosed subject matter relates, in general, to the field of software testing, and more specifically, to machine learning based software testing.

### BACKGROUND

Software enterprises are constantly facing challenges with respect to software testing. Software testing refers to the process of reviewing and validating a software program with respect to its intended behaviors. A discrepancy between the expected behaviors and the actual behaviors is considered a software implementation “bug” that needs to be amended. The tests that are used to validate software behaviors are conventionally programmed manually, e.g., either by the developers who wrote the software code being tested, or by other developers or testing specialists who may not possess sufficient understanding of the original intents of the software program. These tests are then manually executed for verifying that certain features of the software program behave as expected.

However, such a conventional testing process may have its own drawbacks. In one aspect, software developed by a developer may occasionally perform differently from the developer's original intent. This could be due to several potential reasons. By way of example, implementation of the software may contain human errors, or may be limited by the technical capabilities of the underlying hardware or platform, leading to unexpected behaviors. In addition, the developers' original intents may not be clearly defined, leading to potential errors in implementation. For example, in cases where a code generation tool was used by the developers to create the software from a natural language description of the desired software, the code generation tool might have misinterpreted the developers' intent if it is not well defined in the description. In another example, the intents may have not been accurately communicated to other team members responsible for implementing some parts of the software, thus causing incorrect implementation.

In addition, such a conventional testing process is usually slow and costly, as the test writing is typically mundane work, and is time-consuming for developers, thus causing software projects' budgets to increase.

The manually written tests are also error prone. For instance, quality of the test code may fluctuate depending on different developers' experience, effort invested, and/or their prioritization. In addition, mapping complex code behaviors systematically can be a challenging task, even for developers. Usually, there tends to be a high correlation between what the developers sample to test, and what they intended to program in the software, so tests they write may typically miss the un-intended behaviors. Furthermore, example-based tests are often employed in software testing, which use unique samples of expected behaviors, rather than property of the behaviors. Such tests reflect a sparse representation of the expected behaviors, thus making them insufficient, and, in some cases, error prone.

Another challenge in software testing is that software programs are rarely accompanied with clear, precise, and well-documented specifications. Ideally, it is preferred to have a detailed description of what the software is expected to do, as well as a detailed description of what is actually implemented in the software, which will then be compared. However, due to time constraints of the software development life cycle and “short-time-to-market” requirements, software products often come with poor, incomplete description, and in some cases even without any documented specifications. In cases where software programs are accompanied with specifications, the specifications are often not updated as the software programs evolve, which may render the originally documented specifications of little use after several cycles of program evolution.

Therefore, conventional software testing, as described above, suffers from certain limitations when it comes to quality, efficiency, and scalability, etc. It relies heavily on manual coding efforts and human intervention, which may result in testing errors, insufficiencies, and personal biases, etc., thus may affect the testing performance of the software program.

Thus, there is a need in the art for an improved software testing method.

### SUMMARY

In accordance with certain aspects of the presently disclosed subject matter, there is provided a computerized method of automatic software testing, the method comprising: obtaining an input including software code of a software program and metadata thereof; and feeding the input to a machine learning (ML) model to generate a test suite usable for testing the software program and comprising a set of tests meeting a predefined condition, wherein the generating of the test suite comprises: identifying, based on the input, missing information for meeting the predefined condition; generating, based on the missing information, at least one question related to at least one of: one or more expected intents of one or more sections of the software code, or one or more tests for testing the one or more sections, and presenting the at least one question to a user; upon receiving feedback to the at least one question from the user, analyzing the feedback with respect to the predefined condition, and determining whether to generate at least one new question; and in response to an affirmative determination, repeating the generating, presenting, and analyzing with respect to the at least one new question until the predefined condition is met, wherein the set of tests comprised in the generated test suite are selected based on the feedback received in one or more iterations.

In addition to the above features, the method according to this aspect of the presently disclosed subject matter can comprise one or more of features (i) to (xiv) listed below, in any desired combination or permutation which is technically possible:
(i). The metadata can comprise at least one of: software documentation, product description, and code comments.
(ii). The input can be pre-processed prior to being fed to the ML model, the pre-processing comprising at least one of software code analysis and metadata analysis based on at least the following: context selection and minimization of prompt to the ML model.
(iii). The ML model can be a large language model (LLM) which is previously trained during a training phase using a training code set comprising various software codes and reference test codes. In some cases, the training code set is generated by pairing the software codes with corresponding reference test codes based analysis of historical metadata of the software codes stored in a software code repository. The ML model can be trained using reinforcement learning or weakly-supervised learning. In some other cases, the software codes and test codes are unpaired, and the ML model can be trained using unsupervised learning.
(iv). The ML model can be further trained using reinforcement learning based on a training query set including a list of questions and corresponding responses to the questions, optionally accompanied with human-annotated feedback on the responses.
(v). The at least one new question can be generated in an attempt to reduce a total number of questions to be presented to the user upon meeting the predefined condition.
(vi). The predefined condition can specify at least one of code coverage representative of a given percentage of the software code covered by the set of tests, and execution time of the set of tests.
(vii). A set of code sections to be covered by the given percentage can be selected based on rankings of different code sections in the software code.
(viii). The predefined condition can specify that the set of tests includes a minimal number of tests for meeting the predefined condition.
(ix). The generating of the test suite can further comprise: identifying, based on the input or the feedback, that the predefined condition comprises at least two sub-conditions which are contradictory to be met; determining to generate and present a new question with respect to optimization between the two sub-conditions to the user; and upon receiving a decision from the user regarding the optimization, performing the generating, presenting, analyzing, and determining, until the decision is met.
(x). The at least one question can be generated to verify the one or more expected intents of the one or more code sections with the user, and the generating of the test suite can further comprise, upon receiving the feedback to the at least one question, generating the one or more tests for testing the one or more code sections based on the verified expected intents. The at least one new question can be generated to verify the generated tests with the user.
(xi). The one or more expected intents of the one or more code sections can be directly obtained from the metadata, and the generating of the test suite can further comprise generating the one or more tests for testing the one or more code sections based on the one or more expected intents. The at least one question can be generated to verify the generated tests with the user.
(xii). The at least one question can relate to the one or more tests in one of the following aspects: input data of the tests, output data of the tests, and the effectiveness of the tests.
(xiii). The at least one question and the at least one new question can be presented in at least one of natural language or code representation.
(xiv). The method can further comprise presenting the test suite to the user and enabling the user to approve or edit the test suite.

In accordance with other aspects of the presently disclosed subject matter, there is provided a system of automatic software testing, the system comprising a processor and memory circuitry (PMC) configured to: obtain an input including software code of a software program and metadata thereof; and feed the input to a machine learning (ML) model to generate a test suite usable for testing the software program and comprising a set of tests meeting a predefined condition, wherein the generating of the test suite comprises: identifying, based on the input, missing information for meeting the predefined condition; generating, based on the missing information, at least one question related to at least one of: one or more expected intents of one or more sections of the software code, or one or more tests for testing the one or more sections, and presenting the at least one question to a user; upon receiving feedback to the at least one question from the user, analyzing the feedback with respect to the predefined condition and determining whether to generate at least one new question; and in response to an affirmative determination, repeating the generating, presenting, and analyzing with respect to the at least one new question until the predefined condition is met, wherein the set of tests comprised in the generated test suite are selected based on the feedback received in one or more iterations.

This aspect of the disclosed subject matter can comprise one or more of features (i) to (xiv) listed above with respect to the method, mutatis mutandis, in any desired combination or permutation which is technically possible.

In accordance with other aspects of the presently disclosed subject matter, there is provided a non-transitory computer readable medium comprising instructions that, when executed by a computer, cause the computer to perform a method of automatic software testing, the method comprising: obtaining an input including software code of a software program and metadata thereof; and feeding the input to a machine learning (ML) model to generate a test suite usable for testing the software program and comprising a set of tests meeting a predefined condition, wherein the generating of the test suite comprises: identifying, based on the input, missing information for meeting the predefined condition; generating, based on the missing information, at least one question related to at least one of: one or more expected intents of one or more sections of the software code, or one or more tests for testing the one or more sections, and presenting the at least one question to a user; upon receiving feedback to the at least one question from the user, analyzing the feedback with respect to the predefined condition, and determining whether to generate at least one new question; and in response to an affirmative determination, repeating the generating, presenting, and analyzing with respect to the at least one new question, until the predefined condition is met, wherein the set of tests comprised in the generated test suite are selected based on the feedback received in one or more iterations.

This aspect of the disclosed subject matter can comprise one or more of features (i) to (xiv) listed above with respect to the method, mutatis mutandis, in any desired combination or permutation which is technically possible.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates a functional block diagram of a software testing system in accordance with certain embodiments of the presently disclosed subject matter.

FIG. 2 illustrates a generalized flowchart of automatic software testing in accordance with certain embodiments of the presently disclosed subject matter.

FIG. 3 illustrates a generalized flowchart of an optimization process in cases of presence of contradictory sub-conditions in accordance with certain embodiments of the presently disclosed subject matter.

FIG. 4 illustrates a generalized flowchart of a training process of the ML model in accordance with certain embodiments of the presently disclosed subject matter.

FIG. 5 illustrates an exemplary piece of software code for which the ML model as disclosed herein can generate a test suite in accordance with certain embodiments of the presently disclosed subject matter.

FIG. 6 illustrates an exemplary graphical user interface (GUI) with questions and feedbacks in accordance with certain embodiments of the presently disclosed subject matter.

### DETAILED DESCRIPTION OF EMBODIMENTS

In the following detailed description, numerous specific details are set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the following discussions, it is appreciated that throughout the specification discussions utilizing terms such as “obtaining”, “generating”, “training”, “feeding”, “selecting”, “testing”, “identifying”, “receiving”, “analyzing”, “determining”, “repeating”, “pre-processing”, “performing”, “verifying”, “presenting”, “enabling”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the system of software testing and respective parts thereof disclosed in the present application.

The terms “non-transitory computer-readable memory” and “non-transitory computer-readable storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

Embodiments of the presently disclosed subject matter are not described with reference to any particular programming language. It will be appreciated that a variety of programming languages may be used to implement the teachings of the presently disclosed subject matter as described herein.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure, or characteristic described in connection with the embodiment(s), is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the following detailed description, numerous specific details are set forth in order to provide a thorough understanding of the methods and apparatus.

In embodiments of the presently disclosed subject matter, one or more stages illustrated in the figures may be executed in a different order and/or one or more groups of stages may be executed simultaneously, and vice versa.

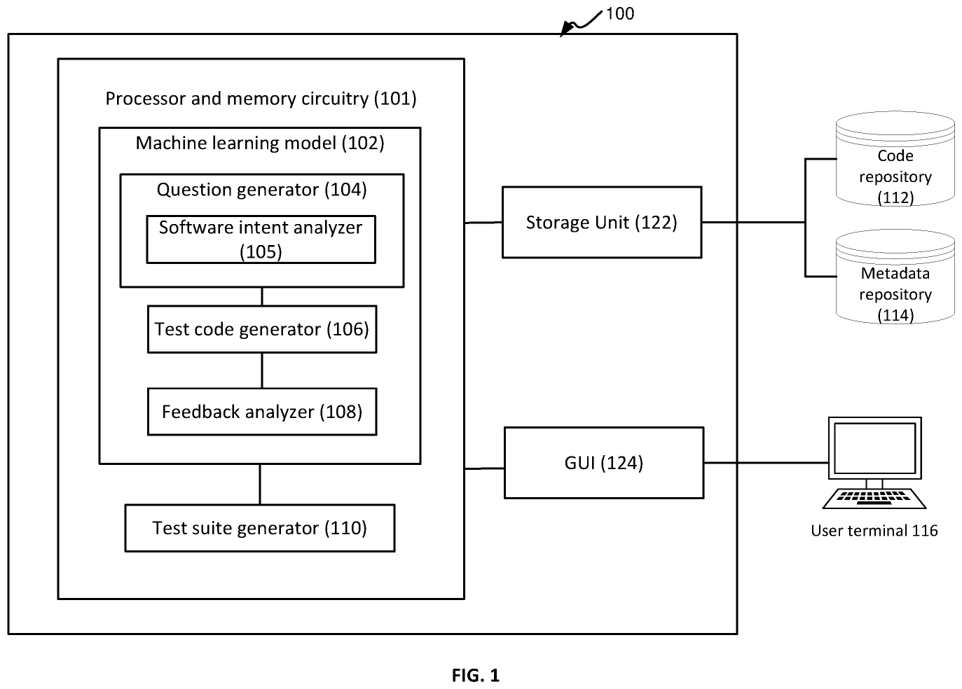

Bearing this in mind, attention is drawn to FIG. 1 illustrating a functional block diagram of a software testing system in accordance with certain embodiments of the presently disclosed subject matter.

The system 100 illustrated in FIG. 1 is a computer-based system that can be used for automatic software testing for a software program (also referred to hereinafter as a software or a program). According to certain embodiments of the presently disclosed subject matter, the system 100 can be a machine-learning based system configured to assist a user (e.g., a developer of the software program, or other developers) in clarifying the desired/intended software behaviors of the program (in particular in cases of lack of well-documented specifications detailing a clear, precise, and updated description of what the software is expected to do), and verifying that the software is accurately programmed and functions as intended. System 100 is thus also referred to as a software testing system in the present disclosure.

System 100 can be operatively connected to one or more external data repositories for storing and providing necessary input data related to a software program, such as, e.g., a code repository 112 and a metadata repository 114. Although illustrated as separate repositories in FIG. 1, in some cases the two types of input data can be partially integrated and stored in the same data repository.

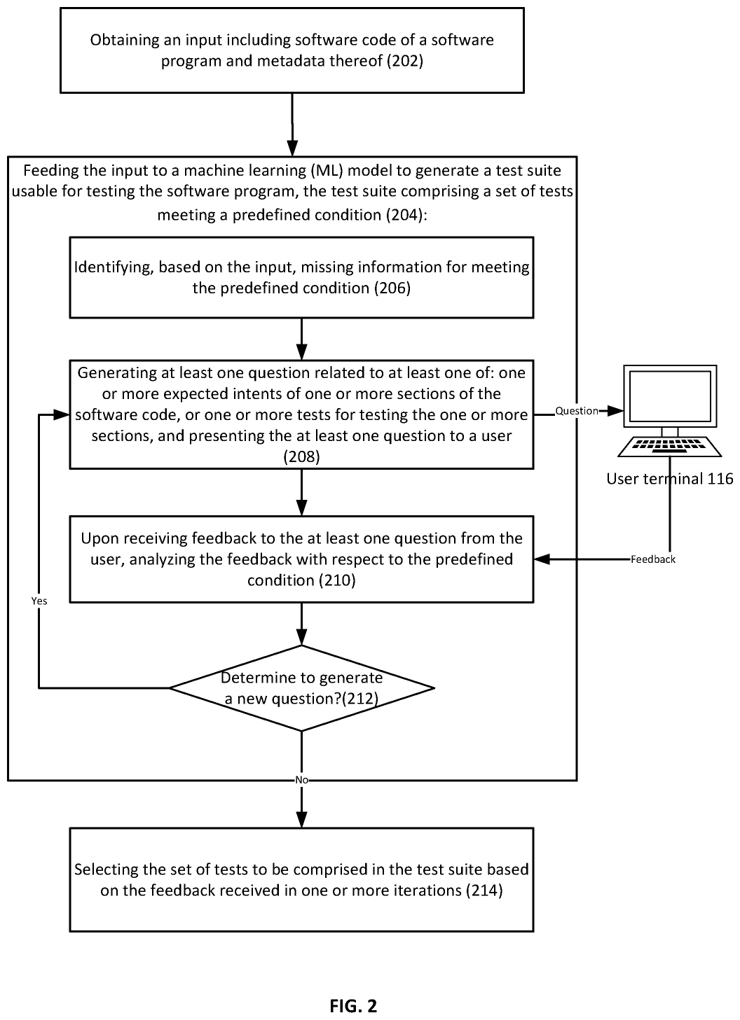

System 100 includes a processor and memory circuitry (PMC) 101 operatively connected to a hardware-based I/O interface 126. PMC 101 is configured to provide all processing necessary for operating the system 100, as further detailed with reference to FIG. 2. PMC 101 can be regarded as comprising a processor (not shown separately in FIG. 1) and a memory (not shown separately in FIG. 1). The processor of PMC 101 can be configured to execute several functional modules in accordance with computer-readable instructions implemented on a non-transitory computer-readable memory or storage medium comprised in the PMC. Such functional modules are referred to hereinafter as comprised in the PMC.

The processor referred to herein can represent one or more general-purpose processing devices such as a microprocessor, a central processing unit, or the like. More particularly, the processor may be a complex instruction set computing (CISC) microprocessor, a reduced instruction set computing (RISC) microprocessor, a very long instruction word (VLIW) microprocessor, or a processor implementing other instruction sets, or processors implementing a combination of instruction sets. The processor may also be one or more special-purpose processing devices such as an application specific integrated circuit (ASIC), a field programmable gate array (FPGA), a digital signal processor (DSP), a network processor, or the like. The processor is configured to execute instructions for performing the operations and steps discussed herein.

The memory referred to herein can comprise a main memory (e.g., read-only memory (ROM), flash memory, dynamic random access memory (DRAM) such as synchronous DRAM (SDRAM) or Rambus DRAM (RDRAM), etc.), and a static memory (e.g., flash memory, static random access memory (SRAM), etc.).

In certain embodiments, functional modules comprised in PMC 101 can include a machine learning (ML) model 102 and a test suite generator 110 which are operatively connected therebetween. The machine learning model 102 can include a question generator 104, a test code generator 106, and a feedback analyzer 108. The PMC 101 can be configured to obtain, from a storage unit 122, an input including software code of a software program and metadata of the software code, and feed the input to the ML model 102 to generate a test suite usable for testing the software program. The test suite comprises a set of tests meeting a predefined condition.

Specifically, the test suite can be generated by the ML model 102 in the following manner. The question generator 104 can be configured to process the input to identify missing information for meeting the predefined condition. The question generator 104 can optionally comprise a software intent analyzer 105, and can be further configured to generate, based on the missing information, at least one question related to at least one of: one or more expected intents of one or more sections of the software code or one or more tests for testing the one or more sections.

The at least one question can be presented to a user, e.g., via a graphical user interface (GUI) 124 to the user. The GUI 124 can be configured to enable user-specified inputs related to system 100. The user may be provided, through the GUI 124, with one or more questions generated by the ML model. The user can provide feedback to the questions via the GUI 124. In some cases, the user can be equipped with a user terminal 116. The user terminal 116 can be any computer-based device, such as, e.g., a mobile phone, a desktop, a portable device, etc. In such cases, the GUI 124 can be regarded as being comprised in the user terminal 116.

Upon receiving feedback to the at least one question from the user, the feedback analyzer 108 can be configured to analyze the feedback with respect to the predefined condition, and determine whether to generate at least one new question. In response to an affirmative determination (i.e., it is determined to generate at least one new question), the generating, presenting, analyzing, and determining, as described above, can be repeated with respect to the at least one new question, until the predefined condition is met. The test code generator 106 can be configured to generate the one or more tests for testing the code sections having clear intents (either initially, or after being clarified with the user). The test suite generator 110 can be configured to select a set of tests based on the feedback received in one or more iterations, to constitute the test suite, as detailed below with reference to FIG. 2.

In some cases, the generated test suite can be presented to the user on the GUI 124. The GUI 124 can provide the user with options of providing feedback on the test suite, such as, e.g., editing and adjusting the tests in the test suite.

Operation of system 100, PMC 101 and the functional modules therein will be further detailed with reference to FIG. 2.

According to certain embodiments, the ML model 102 referred to herein can be implemented as various types of machine learning models, such as, e.g., Artificial Neural Network (ANN), transformer network, regression model, Bayesian network, or ensembles/combinations thereof, etc. The learning algorithm used by the ML model can be any of the following: supervised learning, unsupervised learning, or semi-supervised learning, etc. The presently disclosed subject matter is not limited to the specific type or learning algorithm used by the ML model.

In some embodiments, the ML model 100 can be implemented as a deep neural network (DNN) which includes layers organized in accordance with respective DNN architecture. By way of non-limiting example, the layers of DNN can be organized in accordance with Convolutional Neural Network (CNN) architecture, Recurrent Neural Network architecture, Recursive Neural Networks architecture, Generative Adversarial Network (GAN) architecture, or otherwise. Optionally, at least some of the layers can be organized in a plurality of DNN sub-networks. Each layer of DNN can include multiple basic computational elements (CE) typically referred to in the art as dimensions, neurons, or nodes.

Generally, CEs of a given layer can be connected with CEs of a preceding layer and/or a subsequent layer. Each connection between the CE of a preceding layer and the CE of a subsequent layer is associated with a weighting value. A given CE can receive inputs from CEs of a previous layer via the respective connections, each given connection being associated with a weighting value which can be applied to the input of the given connection. The weighting values can determine the relative strength of the connections and thus the relative influence of the respective inputs on the output of the given CE. The given CE can be configured to compute an activation value (e.g., the weighted sum of the inputs) and further derive an output by applying an activation function to the computed activation. The activation function can be, for example, an identity function, a deterministic function (e.g., linear, sigmoid, threshold, or the like), a stochastic function, or other suitable function. The output from the given CE can be transmitted to CEs of a subsequent layer via the respective connections. Likewise, as above, each connection at the output of a CE can be associated with a weighting value which can be applied to the output of the CE prior to being received as an input of a CE of a subsequent layer. Further to the weighting values, there can be threshold values (including limiting functions) associated with the connections and CEs.

The weighting and/or threshold values of a DNN can be initially selected prior to training, and can be further iteratively adjusted or modified during training to achieve an optimal set of weighting and/or threshold values in a trained DNN. After each iteration, a difference can be determined between the actual output produced by DNN and the target output associated with the respective training set of data. The difference can be referred to as an error value. Training can be determined to be complete when a cost function indicative of the error value is less than a predetermined value, or when a limited change in performance between iterations is achieved. Optionally, at least a part of the DNN subnetworks (if any) can be trained separately prior to training the entire DNN.

A set of DNN input data used to adjust the weights/thresholds of a deep neural network is referred to hereinafter as a training set, or training dataset, or training data. The training of the ML model can be performed by a training module during a training phase, as will be detailed below with reference to FIG. 4.

It should be noted that the above illustrated DNN architecture is for exemplary purposes only, and is only one possible way of implementing the ML model, and the teachings of the presently disclosed subject matter are not bound by the specific model and architecture as described above.

According to certain embodiments, system 100 can comprise a storage unit 122. The storage unit 122 can be configured to store any data necessary for operating system 100, e.g., data related to input and output of system 100, as well as intermediate processing results generated by system 100. By way of example, the storage unit 122 can be configured to receive (e.g., from the external repositories) and store input data including software code and metadata. The storage unit 122 can also be configured to store the pre-trained ML model. Accordingly, these data and/or models can be retrieved from the storage unit 122 and provided to the PMC 101 for further processing. The storage unit 122 can also store output of system 100, such as the generated test suite, etc.

Those versed in the art will readily appreciate that the teachings of the presently disclosed subject matter are not bound by the system illustrated in FIG. 1; equivalent and/or modified functionality can be consolidated or divided in another manner and can be implemented in any appropriate combination of software with firmware and/or hardware.

It is noted that the system 100 illustrated in FIG. 1 can be implemented in a distributed computing environment, in which the aforementioned functional modules shown in FIG. 1 can be distributed over several local and/or remote devices, and can be linked through a communication network.

It should be further noted that in some embodiments, at least part of the ML model 102 (or components thereof), storage unit 122 and/or GUI 124 can be external to the system 100 and operate in data communication with system 100 via an I/O interface. By way of example, the ML model can be pre-trained and stored externally, and can be obtained and processed by system 100. Alternatively, the respective functions of the ML model can, at least partially, be integrated with system 100, thereby facilitating and enhancing the functionalities of the system. By way of another example, the data repositories or storage unit therein can be shared with other systems, or be provided by other systems, including third party equipment.

It should be noted that the presently disclosed software testing system 100 can be implemented in a computer or a computerized machine within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in a client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is described, the term “machine” shall also be taken to include any collection of machines that individually or jointly execute a set (or multiple sets) of instructions to perform any one or more of the methodologies discussed herein.

While not necessarily so, the process of operation of system 100 can correspond to some or all of the stages of the methods described with respect to FIGS. 2-4. Likewise, the methods described with respect to FIGS. 2-4 and their possible implementations can be implemented by system 100. It should therefore be noted that embodiments discussed in relation to the methods described with respect to FIGS. 2-4 can also be implemented, mutatis mutandis as various embodiments of the system 100, and vice versa.

Referring to FIG. 2, there is illustrated a generalized flowchart of automatic software testing in accordance with certain embodiments of the presently disclosed subject matter.

An input including software code of a software program and metadata thereof can be obtained (202) (e.g., by the PMC 101 of system 100). The term “software program” is used interchangeably herein with terms such as “software application”, “software product”, or simply “software”. It can refer to a set of instructions representing a set of modules or procedures that, upon execution, enables a certain type of computer operations and functionalities as designed. Software code (or simply referred to as “code”) of a software program can refer to its source code which is written using a human-readable programming language by its developers. The source code can be retrieved from a code database (such as, e.g., the code repository 112).

In addition to the software code, metadata of the code can be retrieved (e.g., from the metadata repository 114). The metadata can comprise at least one of the following: software documentation, product description, and code comments. In some cases, the metadata includes software documentation which describes how the software operates and/or how to use it. Software documentation can include any of the following: requirements documentation (e.g., description of the software's intended functionality and operations), architecture design documentation, technical documentations (e.g., README files and API documentation), user documentations (e.g., manuals for end-users), etc.

Optionally, the metadata can include a product description which supplies customers with information on features and benefits of a software product. The product description may in some cases be partially overlapped/integrated with the software documentation as described above.

Optionally, the metadata can include code comments (including docstrings) which provide context and clarify intents of functions/sections in the code. Code comments are added with the purpose of enhancing readability, facilitating code reviews, and maintenance. In some cases, code comments can be integrated within the source code. In some other cases, code comments can be processed as documentations external to the source code itself.

In some embodiments, considering that the input of the software code and metadata thereof may be unstructured, it can be pre-processed before being fed into the ML model. By way of example, the pre-processing can include static and/or dynamic analysis of the source code. Static code analysis, also termed static program analysis, refers to the analysis of a computer program that is performed without actually executing the program, in contrast to dynamic analysis which is performed on the program during its execution. The pre-processing can provide a more structured input to the ML model for processing.

Code analysis can be performed by, e.g., smart selection of context (pruning), minimizing the prompt to be provided to the ML model, identifying computer languages of the code, and adapting the prompt template accordingly, etc. The smart context selection can be based on identifying interconnections between the code pieces, e.g., by analyzing the functions called by different modules, which allows to optimize the amount of input and identify more important pieces of context, as needed. The adaptation of a prompt template can direct the prompt creation procedure to choose the right prompt template which fits the specific computer language and/or framework or other detected attributes. The code analysis outcome may be a compressed version of the code, which in some cases allows to overcome the query token size limitation.

Additionally, or alternatively, the pre-processing can optionally include analysis of the metadata. By way of example, metadata analysis can be performed including the smart selection of context and/or the minimization of the prompt, in a similar manner as described above.

The input (or the pre-processed input, e.g., the analysis results), can be fed into a ML model (e.g., the ML model 102) which was previously trained. The ML model can process (204) the input and generate a test suite usable for testing the software program. The test suite comprises a set of tests meeting a predefined condition. The predefined condition refers to a global/overall testing goal/objective that the test suite should achieve. The condition can be defined based on any software testing metric/measure for evaluating the test suite, such as, e.g., code coverage, execution time, etc.

By way of example, the predefined condition can specify that the set of tests in the test suite should cover a given percentage of the software code (i.e., code coverage). For instance, it can be defined in the condition that at least 80% of the code should be covered by the test suite. Different coverage criteria can be used. For instance, the percentage of code coverage can be defined in terms of line coverage, function coverage, statement coverage, or any other types of coverage rules/requirements. Optionally, the predefined condition can further specify that the execution time of the test suite should be under certain time limits.

In some cases, a set of code sections in the software code to be covered by the given percentage can be selected based on rankings of different code sections in the software code. For instance, the code sections in the software code can be ranked based on various standards, such as, e.g., importance of the code sections in the entire software code, presence of metadata associated therewith, the level of discrepancy between code and metadata, etc.

By way of example, some sections of the code may not be accompanied by any clear metadata, such as, e.g., requirement documentation and/or code comments. By way of another example, there may be a discrepancy between the code and the accompanied metadata. The discrepancy can be identified by matching code analysis of a given code section with corresponding metadata analysis. In such cases, these code sections should have a higher priority to be tested. Accordingly, each code section can be ranked with a respective score indicative of the priority to be covered by the test suite, and the code sections to be included in the code coverage as defined in the condition can be selected according to the ranking.

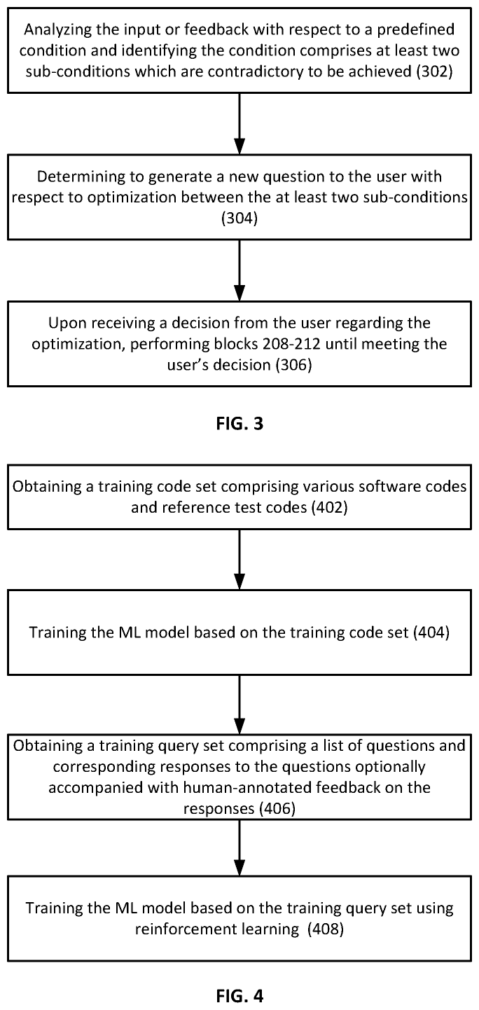

It should be noted that the predefined condition can refer to a single condition, or in some cases can comprise multiple sub-conditions. In some cases, at least two of the sub-conditions may be contradictory to be achieved, such as, e.g., code coverage and execution time, as will be detailed further below with reference to FIG. 3.

Continuing with the description of FIG. 2, for purpose of generating the test suite, the ML model can be designed to ask a user (e.g., a developer) a number of questions to obtain the information needed for understanding/verifying the original intents of the software program and/or generating suitable tests meeting the predefined condition. The ML model is capable of analyzing the user's feedback to the questions, based on it is determined whether/how to ask further questions, or to generate the test suite.

Specifically, the input (or the pre-processed input) can be analyzed to identify (206) any information that is missing for meeting the predefined condition. At least one question can be generated (208) by the ML model based on the identified missing information. The at least one question relates to at least one of one or more expected intents of one or more sections of the software code, or one or more tests for testing the one or more sections. The at least one question can be presented, e.g., via a GUI, to a user.

By way of example, in cases where a previously generated test set exists, the ML model can analyze whether the condition is met or partially met by the pre-existing test set, e.g., how much code coverage is obtained so far, the current execution time of the test set, etc., and what is still missing for meeting the condition.

For instance, assume a piece of software code includes 10 functions. The predefined condition is defined as 80% code coverage, e.g., at least 8 functions out of the 10 should be tested (in this specific example, the code coverage refers to function coverage). When analyzing the input, it is identified that a pre-existing test set covers tests for 7 functions. Thus, one or more tests for another function (i.e., the 8^{th} function) should be generated in order to meet the predefined condition. In cases where the predefined condition specifies a given percentage of code coverage (e.g., 80%) based on rankings of code sections in the software code, the remaining functions can be ranked according to various standards as described above, and the 8^{th} function to be tested can be selected based on the ranking.

Upon identifying the function to be tested, it can be further analyzed whether the original intent of the function as designed or expected (also referred to as design intent or expected intent) is clear, e.g., based on the metadata thereof, such as code comments, and/or other documentations. In one example, the system can infer code behaviors based on the function code and any accompanying documentation thereof, and ask the user to confirm the inferred behaviors. In cases where the intent of the function is unclear/missing, at least one question should be asked to verify the expected intent of the function with the user. For instance, the system may identify a discrepancy between the code and the documentation requirements, in which case a question can be proposed to ask the user to clarify which one is correct, such as, e.g., “the function code applied 20% discount for a member, whereas the documentation suggests 15%. Which one is correct?”.

In cases where the expected intent is clear, however certain necessary information, such as the input data for testing the function, is missing, at least one question can be asked to request the input data from the user. In such cases, the question is related to the input of the tests, thus can be regarded as being related to the tests. It should be noted that the at least one question can be related to the tests in one of the following aspects: input data of the tests, output data of the tests, effectiveness of the tests, etc.

In some cases, if the expected intent is clear and all necessary information is available, the ML model can already generate one or more tests to meet the predefined condition. In such cases, what is missing/needed is the user's confirmation of the generated tests. Thus at least one question related to the tests can be proposed to the user to ask for his/her approval or rejections with respect to the generated tests (e.g., with respect to the effectiveness of the tests).

The at least one question can be presented to the user (e.g., via a GUI through the user terminal 116). Upon receiving feedback to the at least one question from the user, the feedback can be analyzed (210) with respect to the predefined condition, and it can be determined (212) whether to generate at least one new question to the user. In response to an affirmative determination (i.e., it is determined to generate at least one new question), the generating, presenting, analyzing, and determining, as described above with reference to blocks 208-212, can be repeated with respect to the at least one new question until the predefined condition is met. The set of tests to be comprised in the generated test suite can be selected (214) (e.g., by the test suite generator 110) based on the feedback received in one or more iterations.

Continuing with the above example, where the predefined condition is 80% code coverage, assume at least one question (e.g., a first question) was generated and presented to the user to verify the expected intent of the 8^{th} function. After analyzing the user's feedback, it is identified that the user has provided clear intent of the function which enables the ML model to generate the tests. In such cases, tests can be generated (e.g., by the test code generator 106 as illustrated in FIG. 1) for testing the 8^{th} function based on the verified intent.

By way of example, the tests can be generated by the test code generator 106 using unit testing or component testing. Unit testing involves testing individual units of code (e.g., functions or methods) to verify that they are working as expected. Component testing, on the other hand, involves testing larger components of the software (e.g., modules or classes) to ensure that they are working together as intended. This can help identify issues with the interactions between different components and ensure that the overall software behaves as expected.

At this point, what is needed for meeting the predefined condition is to verify with the user whether the generated tests are acceptable (e.g., in terms of the effectiveness of the tests for testing the function). Thus, it can be determined at block 212 to generate a new question to seek the user's feedback for the generated tests, such as, e.g., “please review the generated tests for the function, and provide confirmation or suggestions for modification”.

Accordingly, the process returns to block 208 where at least one new question (e.g., a second question) is generated related to the tests, i.e., to verify the tests with the user. If the user provides affirmative feedback to the new question, e.g., confirmation of the generated tests, the predefined condition is met (per analysis at block 210) and it can be determined at block 212 that there is no need to generate further new questions. Otherwise, if the user provides feedback regarding suggestions to modify/fix the tests, the feedback can be analyzed, and new question(s) can be generated and proposed in a new iteration of blocks 208-212, until the predefined condition is met.

The set of tests (for the selected function) that are eventually confirmed by the user, together with the pre-existing test set, can be included in the test suite. In some cases, the ML model can further verify whether there is any overlap between the newly generated set of tests and the pre-existing test set. If so, the redundant tests can be removed from the test suite so as to keep a minimal number of tests in the test suite while still meeting the predefined condition.

In the above example, if, upon analyzing the user's feedback to the first question, it is identified that the user has not provided clear intent of the function that is sufficient to enables the ML model to generate the tests, it can be determined to generate one or more new questions (e.g., second questions) to further clarify the intent with the user, until the intent is sufficiently clear for the ML model to generate the tests. In response to the clarified intent, one or more iterations of generating questions for the purpose of verifying tests with the user can be performed in a similar manner, until the tests are confirmed by the user and the predefined condition is met.

Similarly, in cases where the intent is clear from the beginning of the process, and only the input data for testing the function is missing, as described above, at least one question can be generated and presented to the user to request the input data. Upon the user providing sufficient input data (through one or more iterations), the ML model can generate tests using the input data. New question(s) can be generated to seek the user's feedback for the generated tests.

It should be noted that in some cases, the tests to be comprised in the test suite may be generated during different iterations. For instance, when proposing a set of tests to the user to review, the user may confirm some of the tests, while suggesting changes to the rest. In such cases, the rest of tests will be modified and proposed to the user in the next iteration, which, upon confirmation, will be included in the test suites.

In another example, a first set of tests for covering a first part of code sections may be proposed first, which, upon being confirmed by the user, can serve as the basis for generating a second set of tests for a second part of code sections. Therefore, the test sets to be comprised in the test suite in the end can be based on the feedback (and the corresponding generated tests) from one or more iterations.

As described above, in some embodiments, the predefined condition may comprise a plurality of sub-conditions. In some cases, at least two sub-conditions of the plurality of sub-conditions may be contradictory to be achieved, such as, e.g., code coverage and execution time of the tests. FIG. 3 illustrates a generalized flowchart of an optimization process in cases of presence of contradictory sub-conditions in accordance with certain embodiments of the presently disclosed subject matter.

Assume an exemplary predefined condition is specified by the user as comprising the following sub-conditions: code coverage of 90% and test execution time of under 1 minute. Upon analyzing the input (as described with reference to block 206) or the feedback (as described with reference to block 210), it is identified (302) that in order to achieve 90% code coverage, the system needs to generate additional tests which will cause the execution time of the entire test set to exceed the 1 minute requirement, thus making these two sub-conditions as contradictory to be achieved one to the other.

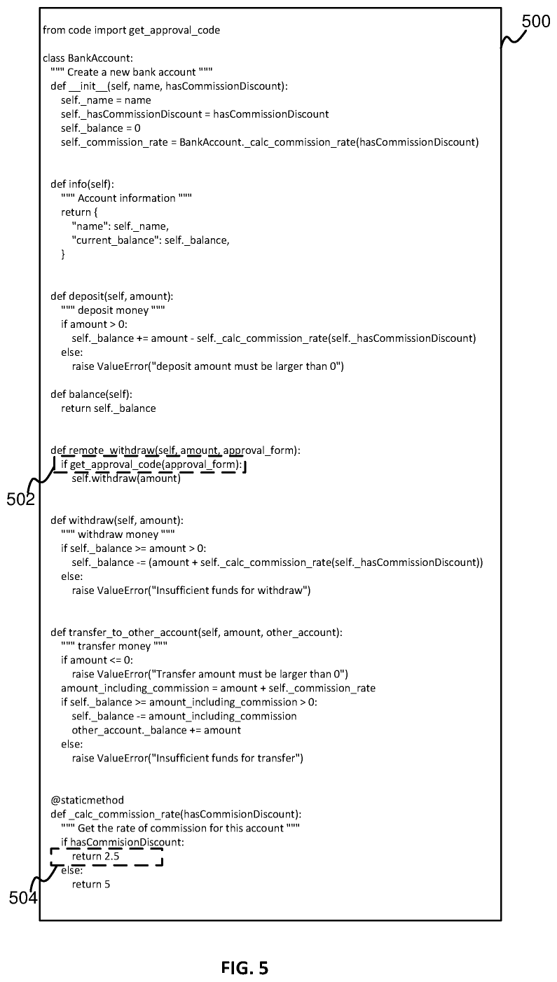

In such cases, it can be determined (304) to generate a new question to the user with respect to optimization between the two sub-conditions. By way of example, the generated question can present the contradiction between the two sub-conditions to the user, and ask the user how to optimize between the contradictory conditions. For instance, the generated question may propose to the user whether he/she is willing to relax the requirement of at least one of the sub-conditions, such as, e.g., maintaining the 90% code coverage regardless of the execution time, or the other way around, as will be exemplified further below with reference to FIG. 5.

Upon receiving the user's feedback of a decision regarding the optimization, the operations of generating, presenting, analyzing, and determining, as described with reference to blocks 208-212 can be performed (306) until the optimization decision is met. By way of example, in cases where the user decides to relax the execution time while maintaining the 90% code coverage (the decision constitutes an optimized condition), the process of generating and presenting questions to the user, analyzing user's feedback, and determining whether to generate new questions as described in blocks 208-212, can be performed similarly as described above with refence to FIG. 2 until the decision (i.e., the optimized condition) is met.

It should be noted that in some cases the predefined condition may comprise a plurality of sub-conditions which are not contradictory to each other (e.g., they are compatible to each other). In such cases, a muti-objective optimization that involves more than one objective function to be optimized simultaneously can be applied. It should further be noted that in cases where at least two sub-conditions of the plurality of sub-conditions are contradictory to be achieved, it may or may not be required to relax at least one of them in order to meet such conditions.

It should be noted that the questions generated by the ML model, such as the at least one question, the at least one new question, etc., can be presented in various forms, such as, e.g., natural language and/or code representation, and the present disclosure is not limited by a specific type of representation. The code representation can include tests, such as, e.g., unit or component tests. Using tests in questions can greatly improve clarity in understanding the developer's intents, as they are expressed in a formal language that can be easily understood by developers.

As described above, the ML model used for generating the test suite can be previously trained during a training phase. The ML model can be implemented as various types of machine learning models as exemplified above, and can be trained using different learning algorithms, such as, e.g., supervised learning, reinforcement learning, etc. The training of the ML model can be performed either externally by a training system (i.e., external with respect to the system 100), and retrieved upon being requested, or internally within the system 100. FIG. 4 illustrates a generalized flowchart of a training process of the ML model in accordance with certain embodiments of the presently disclosed subject matter.

A training code set can be obtained (402), comprising various software codes (e.g., code files of a large variety of computer languages, frameworks, and code types) and reference test codes, and the ML model can be trained (404) based on the training set.

In some embodiments, the software codes can be paired/associated with corresponding reference test codes. The reference test codes may include positive, negative tests and in some cases also test suite samples. Negative tests refer to tests that do not test anything on the target software code, but rather aim to test a completely different software code which is not related to the target software code. This type of tests can be used as negative training samples for the ML model which the model should not learn to output, in contrary to positive tests which the model aims to learn and output for testing the target software code. Optionally, the associated reference test codes may be ranked according to estimated relevancy to test the software codes, e.g., from most relevant to not relevant at all. A test suite sample can comprise a range of reference test codes ranked according to its relevancy to test the software codes, including certain positive tests and optionally some negative tests. In such cases, the ML model can be trained using reinforcement learning or weakly-supervised learning based on the training code set. Specifically, the ML model can generate tests for testing the software codes, and the generated tests can be compared with the reference test codes, where a loss function can be calculated based on the difference between the generated test codes and the reference test codes. In some cases, additionally or alternatively, the loss can be calculated according to feedback from users or annotators who provide a score for each generated test codes or alternatively rank the several tests or test suites.

In some embodiments, a training code set creation or transformation process may be executed in order to pair software codes with their associated reference test codes. As an example, the process may include analysis of software code repositories, including their historical metadata, such as commits, pull requests, branch merges, and other data, collected as part of a distributed version control system that tracks changes in any set of computer files. Analysis of metadata may include matching of reference test codes with software codes creating the reference test codes. As an example, certain commits or pull requests may include a natural language description indicating that certain test codes may be related to a certain bug or software codes, and that indication can be considered in the analysis. For example, different indication may be used to estimate ranks for different test codes.

In some embodiments, the various software codes and various reference test codes in the training code set are not paired/associated one to the other. In such cases, the ML model can be trained in an unsupervised manner. By way of example, for each piece of software code, it can be partially fed into the model, and the model can learn to generate the remaining part, thus complete the code. The generated code can be compared with the original complete code and a loss can be calculated, based on the difference thereof. This is also referred to as self-supervised learning in some cases.

It should be noted that in some cases unsupervised or self-supervised learning can also be used when the training code sets are paired with corresponding reference test codes. For example, for each piece of software code, it can be fed into the model, together with parts of the reference test codes, and the model can learn to generate the remaining part, thus complete the test codes. The generated code can be compared with the original complete code, and a loss can be calculated based on the difference therebetween.

In some further embodiments, in combination with the aforementioned supervised or unsupervised learning, the ML model can be further trained using reinforcement training. A training query set can be obtained (406), including a large list of questions/queries, the corresponding responses to the questions, optionally accompanied with human-annotated feedback on the responses, and the ML model can be further trained (408) based on the training query set using reinforcement training. The ML model can be trained to generate questions and analyze responses in a way that maximizes the accuracy of the representation of the user's intent, and in some cases with a minimum amount of questions. By way of example, the ML model can be trained using a reward function that rewards it for generating questions that elicit useful information from the user and for accurately representing the user's intent. As the model interacts with the user and receives feedback on its performance, it would be able to adapt and improve its performance over time.

Upon training, the ML model can possibly be fine-tuned on a specific domain or specific application for the purpose of improving its performance in the specific domain. Such fine-tuning can be performed based on training data dedicated to the specific domain or specific application.

In some cases, the ML model can be adapted to learn from previous interactions with specific developers, allowing it to better understand and anticipate their specific needs, preferences, inclinations, or styles of answering questions or providing information.

In some embodiments, the at least one new question as described with reference to block 212 can be generated in an attempt to minimize/reduce the total number of questions to be presented to the user upon meeting the predefined condition. The reduction of the total number of questions (also referred to as reduction of the number of iterations or the rounds of interactions with the user) can be realized inherently by the use of reinforcement learning which can maximize the outcome of a sequence of steps (reward). In reinforcement learning there is generally a relation between the number of steps and the desired error (between the prediction and the expectation, such as the predefined condition). For any given error, the minimal steps needed can be calculated using the following function:

$$N = \frac{log ( \frac{2 {R}_{max}}{ϵ ( 1 - γ )} )}{log ( \frac{1}{γ} )}$$

where N refers to the number of steps (in this case interactions/questions to the users until the condition is met), Rmax refers to the maximal reward for asking the most informative question in relation to the predefined condition, Epsilon signifies the error, and gamma is a discount factor in the interval [0,1], which is basically a constant that determines how much the reinforcement learning agent cares about rewards in the distant future relative to those in the immediate future.

In some cases, the predefined condition can specify that the set of tests includes a minimal number of tests for meeting the predefined condition. This may be achieved by, e.g., mapping the relative contribution of each test to achieving the predefined condition, and using optimization techniques to select the smallest subset of tests which still satisfies the predefined condition. For example, assume the predefined condition relates to code coverage. Test A covers code sections S1, S2, Test B covers code sections S2, S3, S4, and Test C covers S3, S4, S5. In this case, Test B can be omitted, as any of the code sections it covers is already covered by Tests A and C. Thus, the minimal test suite will include Test A and Test C.

It should be noted that the terms “minimize”, “minimal”, or “minimum” used herein refer to an attempt to reduce a number/value to a certain level/extent (which can be predefined, or based on certain predefined relation/function), but do not necessarily have to reach the actual minimum.

The question generation and feedback process for generating the test suite as described with reference to FIG. 2 can be applied to different scenarios depending on the specific inputs. By way of example, in cases where the expected intents of one or more code sections in the software code are unclear/missing, the at least one question can be generated to verify the expected intents of the one or more code sections with the user. Upon receiving, from the user, the feedback to the at least one question indicative of verified expected intents, the ML model can generate one or more tests for testing the one or more code sections based on the verified expected intents. In such cases, the at least one new question can be generated to verify the generated tests with the user.

By way of another example, in cases where the expected intents of one or more code sections in the software code are already clear, and no other information is missing, the ML model can directly generate one or more tests for testing the one or more code sections based on the expected intents. In such cases, the at least one question can be generated to verify the generated tests with the user. If the user confirms the tests, there is no need to generate a new question, and the test suite can be generated based on the confirmed tests.

Once the test suite is generated, the test suite can be presented to the user via the GUI, which enables the user to review, approve, or further edit the test suite.

In some cases, the system 100 as proposed above can be integrated into developers' existing workflow, allowing them to easily access and use the ML-based assistance as needed. The developers can also provide their feedback and additional information to the system, enabling on-going updates and improvements to the model. The additional information may include, e.g., updates of code and/or metadata, and data structures and/or distributions thereof, which are used across the software program.

Optionally, the ML-based system may use software instrumentation, tracing tools, and methods in staging and development environments to retrieve more information on data structures, data distributions, and behavior options of the software program under test. This allows the system to generate more relevant and useful questions as it can consider data and behaviors that are expected from the software when it will be actually used. By analyzing the data structure and distribution in the staging and development environments, the system is able to further identify patterns and relationships that may be relevant to clarifying the developer's intent. The use of software instrumentation and tracing also allows the system to obtain data samples from these environments, which can be used to test and validate the accuracy of its representation of the developer's intent, as well as providing specific examples to the developer when performing the verification process with the developers. Overall, the use of software instrumentation and tracing in staging and development environments enables the ML-based system to improve the verification process and provide more effective assistance to developers.

Referring to FIG. 5 now, there is illustrated an exemplary piece of software code for which the ML model as disclosed herein can generate a test suite in accordance with certain embodiments of the presently disclosed subject matter.

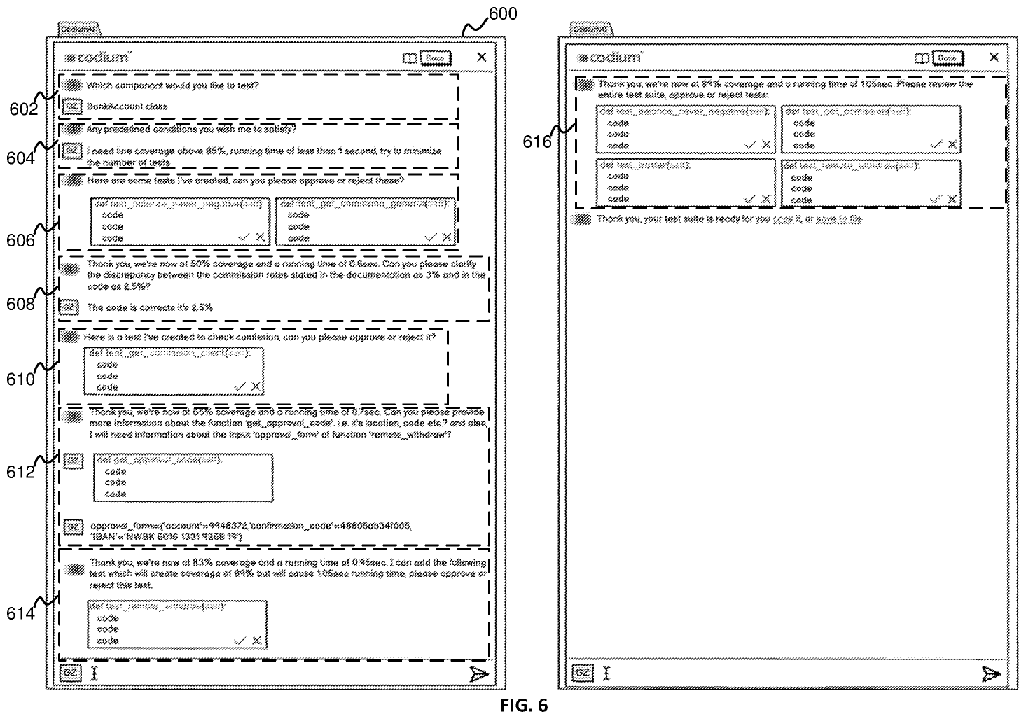

For a given software program which typically comprises various components, the ML model can first ask the user with respect to the target software component(s) to be tested. By way of example, the ML model can propose a first question to the user “Which component of the present software program would you like to test?”, as exemplified in the GUI 600 illustrated in FIG. 6. The user can reply with the component of interest, e.g., the BankAccount class, as illustrated in 602 of FIG. 6. In some cases, identification of the component to be tested can be implemented as a preliminary step prior to the interaction between the ML model and the user. For instance, the user can select a component to be tested in his code repository, and the interaction starts based on this initial input.

As illustrated in FIG. 5, exemplified software code 500 of the BankAccount class has around 50 lines, including code comments and docstrings. In addition, the code is accompanied by brief software documentation, including the following description:

“The software code defines a class of Bank Account. The BankAccount class is initialized with the account owner's name and the type of account (e.g., whether the owner is entitled to a commission discount or not). Accounts with a commission discount pay 3% for each commissionable operation, while accounts without a commission discount (i.e., non-discount accounts) pay 5% for each commissionable operation. The class includes a number of functions/methods within the class that define various bank account operations, such as, e.g., deposit, balance, withdraw, remote withdraw, etc.”

The ML model can then ask the user regarding any predefined condition to be satisfied by the test suite to be generated for testing the above code. In the present example, the user provides a condition specifying two sub-conditions, e.g., code coverage of 85% and test execution time of less than 1 second, as illustrated in 604 of FIG. 6. Similarly, in some cases, provision of the predefined condition can be implemented as a preliminary step prior to interaction between the ML model and the user.

An input including the software code 500 and the metadata thereof (including the code comments and docstrings embedded in the code, as well as the accompanying documentation as illustrated above), can be fed into the ML model.

The ML model can analyze the input and identify any missing information for achieving the predefined condition. For instance, the model can examine the code, identify the code sections which are not covered by any tests, and determine for which code sections the new tests should be generated so as to meet the condition.

In the present example, upon the initial analysis, the ML model identifies that some tests can already be generated based on the existing information. By way of example, the ML model can create a test for testing the bank account balance which should not be negative. By way of another example, the ML model can create another test for testing the general behavior of the function of getting commission for a bank account. The ML model can propose the created tests to the user, to ask for the user's approval or rejection, as illustrated in 606 of FIG. 6.

Upon the user providing his feedback to these tests, the ML model can verify the present status with respect to the predefined condition, and identify that the current tests reaches 50% code coverage with an execution time of 0.6 seconds.

The ML model then identifies certain missing information for the code sections to be tested. For example, the function “remote_withdraw” requires an input of “approval_form” and a function “get_approval_code” (as illustrated in the line 502) for which no reference/information has been provided. Therefore, the ML model cannot generate tests for testing this function. In addition, a discrepancy between the code and the documentation of the function “_calc_commission_rate” is identified. Specifically, the documentation specifies that accounts with a commission discount pay 3% for each commissionable operation, whereas the code implements a commission discount of 2.5% for accounts having the commission discount (as illustrated in the line 504). Such discrepancy may prevent many tests to be generated, since a few functions in the code call for the function “_calc_commission_rate”.

Based on the above analysis, the ML model can determine that the best next step is to generate a question with respect to the discrepancy (other than inquiring regarding the missing input), since this discrepancy affects the ability to generate many other tests. The ML model then generate a question, such as, e.g., “can you please clarify the discrepancy between commission rates stated in the documentation as 3% and in the code as 2.5%?”. The user then provides the feedback that the code is correct, as illustrated in 608 of FIG. 6.

Based on the user's feedback, the ML model can generate a test for checking commissions for bank clients that have commission discount, and ask the user to approve or reject it, as illustrated in 610 of FIG. 6.

Assuming that the user has confirmed the generated tests in his/her feedback, the ML model then analyzes the current status with respect to the predefined condition, and finds that the code coverage reaches 65% with an execution time of 0.7 seconds. The ML model then asks the user to provide the previously-identified missing information with respect to the function “get_approval_code” and the input of “approval_form”. The user provides the feedback for completing the missing information, as illustrated in 612 of FIG. 6. Based on the feedback from the user, the ML model is able to generate more tests. The model then analyzes the current status with respect to the predefined condition, and finds that the code coverage reaches 83% with an execution time of 0.95 seconds. After considering options of the next step for meeting the condition, the model proposes to the user to generate an additional test which will reach a code coverage of 89%, thus satisfying the first sub-condition of 85% code coverage, but will cause 1.05 seconds of execution time, which exceeds the required time in the second sub-condition, as illustrated in 614 of FIG. 6.

When proposing the above test to the user, the ML model also verified that there is no overlap between the newly generated tests and pre-existing tests, thus no tests can be removed so as to meet the sub-condition of 1 second execution time. In such cases, the two sub-conditions are regarded as being contradictory to be met one to the other, which requires the user to provide a decision regarding optimization between the two sub-conditions, as described above with reference to FIG. 3.

Alternatively, the ML model can also ask the user to choose between two options: “is it acceptable to have an execution time of 1.05 s in order to reach 89% code coverage, or would you rather maintain the 1 s execution time while reaching only 83% code coverage?”.

Assuming that the user provides a decision regarding the optimization, e.g., the user confirmed the proposed test illustrated in 614, the predefined condition is met. The ML model can propose the entire test suite to the user for final review, e.g., to approve or reject the tests in the test suite, as illustrated in 616 of FIG. 6. Once the user confirms the test suite, the ML model can enable the user to copy the test suite, or save it to local files.

It should be noted that examples illustrated in the present disclosure, such as, e.g., the exemplary software code and metadata, the exemplary questions generated by the ML model and feedbacks thereof, the ML models and the training thereof, etc., are illustrated for exemplary purposes, and should not be regarded as limiting the present disclosure in any way. Other appropriate examples/implementations can be used in addition to, or in lieu of the above.

Among advantages of certain embodiments of the presently disclosed subject matter as described herein is the capability of providing automatic software testing of a software program based on machine learning, where the ML model is capable of asking the user a sequence of questions to verify the original intents of the software code and generate tests meeting a predefined condition, without having any prior knowledge with respect to the specific domain of the software program to be tested.

Among further advantages of certain embodiments of the presently disclosed subject matter as described herein is that the predefined condition defines a global testing goal or objective for the ML model to focus on during each iteration of the interactions. In some cases, the predefined condition may specify that the test suite should include a minimal number of tests meeting the predefined condition, thus enabling generating a compact and optimal test suite. In some cases, the predefined condition may include contradictory sub-conditions, where the ML model is capable of identifying the contradiction, proposing optimized solutions to the user, and generating a test suite based on the user's decision.

Among further advantages of certain embodiments of the presently disclosed subject matter as described herein is that in some cases, the ML model is capable of proposing a minimal number of questions to the user (i.e., having minimal/reduced number of interactions with the user) for achieving the predefined condition, thus saving the user time and effort, and improving the efficiency of creating the test suite.

Overall, the proposed ML-based system allows developers to communicate more easily their intent to others, such as other developers or users, and offers a valuable tool for developers to streamline and improve the development of software.

It is to be understood that the present disclosure is not limited in its application to the details set forth in the description contained herein or illustrated in the drawings.

It will also be understood that the system according to the present disclosure may be, at least partly, implemented on a suitably programmed computer. Likewise, the present disclosure contemplates a computer program being readable by a computer for executing the method of the present disclosure. The present disclosure further contemplates a non-transitory computer-readable memory tangibly embodying a program of instructions executable by the computer for executing the method of the present disclosure.

The present disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the present disclosure as hereinbefore described without departing from its scope, defined in and by the appended claims.

1-18. (canceled)

19. A computerized method of automatic software testing, the method comprising:
obtaining an input including software code of a software program and metadata thereof; and
feeding the input to a machine learning (ML) model to generate a test suite usable for testing the software program, the test suite comprising a set of tests meeting a predefined condition representing a testing goal that the test suite expects to achieve,
wherein the generating of the test suite comprises:
identifying, based on the input, missing information from the input for meeting the predefined condition;
generating, based on the missing information, at least one question related to at least one of: one or more expected intents of one or more sections of the software code, or one or more tests for testing the one or more sections, and presenting the at least one question to a user;
upon receiving feedback to the at least one question from the user, analyzing the feedback with respect to the predefined condition, and determining whether to generate at least one new question; and
in response to an affirmative determination to generate at least one new question, repeating the generating, presenting, and analyzing with respect to the at least one new question, until the predefined condition is met;
wherein the set of tests comprised in the generated test suite are selected based on the feedback from the user received in one or more iterations of the generating, presenting, and analyzing.

20. The computerized method according to claim 19, wherein the metadata comprises at least one of: software documentation, product description, and code comments.

21. The computerized method according to claim 19, wherein the input is pre-processed prior to being fed to the ML model, the pre-processing comprising at least one of software code analysis and metadata analysis based on at least context selection and minimization of prompt to the ML model.

22. The computerized method according to claim 19, wherein the ML model is a large language model (LLM) which is previously trained during a training phase using a training code set comprising various software codes and reference test codes.

23. The computerized method according to claim 22, wherein the training code set is generated by pairing the software codes with corresponding reference test codes based on an analysis of historical metadata of the software codes stored in a software code repository.

24. The computerized method according to claim 22, wherein the ML model is further trained using reinforcement learning based on a training query set including a list of questions and corresponding responses to the questions.

25. The computerized method according to claim 19, wherein the at least one new question is generated in an attempt to reduce a total number of questions to be presented to the user upon meeting the predefined condition.

26. The computerized method according to claim 19, wherein the predefined condition specifies at least one of code coverage representative of a given percentage of the software code covered by the set of tests, and execution time of the set of tests.

27. The computerized method according to claim 26, wherein a set of code sections to be covered by the given percentage is selected based on rankings of different code sections in the software code.

28. The computerized method according to claim 19, wherein the predefined condition specifies that the set of tests includes a minimal number of tests for meeting the predefined condition.

29. The computerized method according to claim 19, wherein the generating of the test suite further comprises:
identifying, based on the input or the feedback, that the predefined condition comprises at least two sub-conditions which are contradictory to be met;
determining to generate and present a new question with respect to optimization between the two sub-conditions to the user; and
upon receiving a decision from the user regarding the optimization, performing the generating, presenting, analyzing and determining, until the decision is met.

30. The computerized method according to claim 19, wherein the at least one question is generated to verify the one or more expected intents of the one or more code sections with the user, and the generating of the test suite further comprises, upon receiving the feedback to the at least one question, generating the one or more tests for testing the one or more code sections based on the verified expected intents, and wherein the at least one new question is generated to verify the generated tests with the user.

31. The computerized method according to claim 19, wherein the one or more expected intents of the one or more code sections are directly obtained from the metadata, and the generating of the test suite further comprises generating the one or more tests for testing the one or more code sections based on the one or more expected intents, and wherein the at least one question is generated to verify the generated tests with the user.

32. The computerized method according to claim 19, wherein the at least one question relates to the one or more tests in one of the following aspects: input data of the tests, output data of the tests, and effectiveness of the tests.

33. The computerized method according to claim 19, wherein the at least one question and the at least one new question are presented in at least one of natural language or code representation.

34. The computerized method according to claim 19, further comprising presenting the test suite to the user and enabling the user to approve or edit the test suite.

35. A computerized system of automatic software testing, the system comprising a processor and memory circuitry configured to:
obtain an input including software code of a software program and metadata thereof; and
feed the input to a machine learning (ML) model to generate a test suite usable for testing the software program, the test suite comprising a set of tests meeting a predefined condition representing a testing goal that the test suite expects to achieve,
wherein the generating of the test suite comprises:
identifying, based on the input, missing information from the input for meeting the predefined condition;
generating, based on the missing information, at least one question related to at least one of: one or more expected intents of one or more sections of the software code, or one or more tests for testing the one or more sections, and presenting the at least one question to a user;
upon receiving feedback to the at least one question from the user, analyzing the feedback with respect to the predefined condition, and determining whether to generate at least one new question; and
in response to an affirmative determination to generate at least one new question, repeating the generating, presenting, and analyzing with respect to the at least one new question, until the predefined condition is met;
wherein the set of tests comprised in the generated test suite are selected based on the feedback from the user received in one or more iterations of the generating, presenting, and analyzing.

36. The computerized system according to claim 35, wherein the at least one new question is generated in an attempt to reduce a total number of questions to be presented to the user upon meeting the predefined condition.

37. The computerized system according to claim 35, wherein the predefined condition specifies at least one of code coverage representative of a given percentage of the software code covered by the set of tests, and execution time of the set of tests.

38. A non-transitory computer readable storage medium tangibly embodying a program of instructions that, when executed by a computer, cause the computer to perform a method of automatic software testing, the method comprising:
obtaining an input including software code of a software program and metadata thereof; and
feeding the input to a machine learning (ML) model to generate a test suite usable for testing the software program, the test suite comprising a set of tests meeting a predefined condition representing a testing goal that the test suite expects to achieve,
wherein the generating of the test suite comprises:
identifying, based on the input, missing information from the input for meeting the predefined condition;
generating, based on the missing information, at least one question related to at least one of: one or more expected intents of one or more sections of the software code, or one or more tests for testing the one or more sections, and presenting the at least one question to a user;
upon receiving feedback to the at least one question from the user, analyzing the feedback with respect to the predefined condition, and determining whether to generate at least one new question; and
in response to an affirmative determination to generate at least one new question, repeating the generating, presenting, and analyzing with respect to the at least one new question, until the predefined condition is met;
wherein the set of tests comprised in the generated test suite are selected based on the feedback from the user received in one or more iterations of the generating, presenting, and analyzing.
